(19) United States
(12) Patent Application Publication
(10) Pub. No.: US 2014/0251356 A1
(43) Pub. Date: Sep. 11, 2014

(54) ELECTRONIC CIGARETTE WITH PROLONGED HEATING PROTECTION AND PROTECTION METHOD OF THE SAME

(71) Applicant: Zhiyong Xiang, Shenzhen (CN)

(72) Inventor: Zhiyong Xiang, Shenzhen (CN)

(21) Appl. No.: 13/867,695

(22) Filed: Apr. 22, 2013

(30) Foreign Application Priority Data
Mar. 5, 2013 (CN) 201310069690.1

(51) Int. Cl. A24F 47/00; G05B 15/02

(52) U.S. Cl. CPC A24F 47/008; G05B 15/02
USPC 131/329; 700/297

(57) ABSTRACT

The present invention relates to an electronic cigarette with prolonged heating protection and a protection method of the same. The electronic cigarette can avoid generating peculiar smell due to long time heating processes, and can also avoid scald injuries and fire accidents caused by too high temperatures.

### CROSS-REFERENCE TO RELATED APPLICATIONS

This non-provisional application claims priority under 35 U.S.C. §119(a) on Patent Application No. 201310069690.1 filed in P.R. China on Mar. 5, 2013, the entire contents of which are hereby incorporated by reference.

### FIELD OF THE INVENTION

This present invention relates to electronic products, and more particularly to an electronic cigarette with prolonged heating protection and a protection method of using the same.

### BACKGROUND OF THE INVENTION

In smoking processes of most current electronic cigarettes, a heating unit inside an atomizer may keep working for a long time due to users' operations or malfunctions of a sensor. Thus, temperatures inside and outside the atomizer may become too high, and tobacco tar received in the atomizer may create peculiar smell though the atomization of the tobacco tar. Furthermore, security problems such as scald injuries and fire accidents may occur due to the too high temperatures.

### SUMMARY OF THE INVENTION

The object of the present invention is to provide an electronic cigarette with prolonged heating protection and a protection method of the same, thereby solving the problem that some current electronic cigarettes are unable to prevent temperatures of atomizers thereof from being too high.

The invention relates to an electronic cigarette with prolonged heating protection, characterized in that the electronic cigarette with prolonged heating protection includes:

a sensor used to produce a smoking start signal upon sensing a beginning of a smoking process and produce a smoking finish signal upon sensing an end of a smoking process;

a time controller connected to the sensor and setting a preset smoking time T0;

a heating unit connected to the time controller and used to create a high temperature to atomize tobacco tar inside the electronic cigarette;

a semi-conductor switch used to control work states of the heating unite; and

a power supply module connected to the heating unit via the semi-conductor switch; the semi-conductor switch further connected to the time controller;

wherein when the time controller receives the smoking start signal, the time controller turns the semi-conductor switch on and enables the power supply module to supply power to the heating unit, and the time controller begins to do time counting upon receiving the smoking start signal;

if the counted time is longer than or equal to the preset smoking time T0, the time controller turns the semi-conductor switch off and forces the power supply module to stop supplying power to the heating unit;

and when the time controller receives the smoking end signal, the time controller turns the semi-conductor switch off and forces the power supply module to stop supplying power to the heating unit.

A time deleting device is mounted inside the time controller, and the time deleting device is used to deleting time records stored in the time controller when the time controller receives a smoking end signal.

A length of preset the smoking time T0 ranges from 3 to 20 seconds.

The semi-conductor switch is a MOSFET.

The present invention also relates to a prolonged heating protection method for an electronic cigarette, characterized in that the method includes these steps:

Step1: presetting a smoking time T0;

Step2: using a sensor to detect a smoking start signal; if the sensor detects the smoking start signal, using a time controller to turn a semi-conductor switch on and connect a heating unit with a power supply module, using the heating unit to start heating, using a time controller to begin to do time counting at the same time, and turning to Step3;

if the sensor does not detects the smoking start signal, using the sensor to continue to detect the smoking start signal;

Step3: determining whether the smoking time is shorter then the preset smoking time T0; if the smoking time is shorter then the preset smoking time T0, turning to Step4;

if the smoking time is longer than or equal to the preset smoking time T0, using the time controller to turn the semi-conductor off and disconnect the heating unit from the power supply module;

Step4: detecting a smoking end signal; if the smoking end signal is detected, using the time controller to turn the semi-conductor off and disconnects the heating unit from the power supply module;

if the smoking end signal is not detected, turning to Step3.

Step4 further includes deleting time records stored in the time controller when the time controller turns the semi-conductor off and disconnects the heating unit from the power supply module.

Range of the preset smoking time T0 is from 3 to 20 seconds.

By adopting the electronic cigarette with prolonged heating protection and the protection method of the same, the circuit can be switched off automatically when the heating time exceeds the preset time, thereby stopping the heating process. In this way, the electronic cigarette can avoid generating peculiar smell due to long time heating processes, and can also avoid scald injuries and fire accidents caused by too high temperatures.

### BRIEF DESCRIPTION OF THE DRAWINGS

FIG. 1 illustrates a schematic diagram of an electronic cigarette with prolonged heating protection and a protection method of the same according to the present invention;

FIG. 2 illustrates a circuit diagram of the electronic cigarette with prolonged heating protection according to the present invention;

FIG. 3 illustrates a flow chart of the protection method of the electronic cigarette according to the present invention.

### DETAILED DESCRIPTION OF THE PREFERRED EMBODIMENT

In order to understand the technical features, purpose and the effect of the present invention more clearly, the specific embodiments of the present invention will be described referring to the drawings.

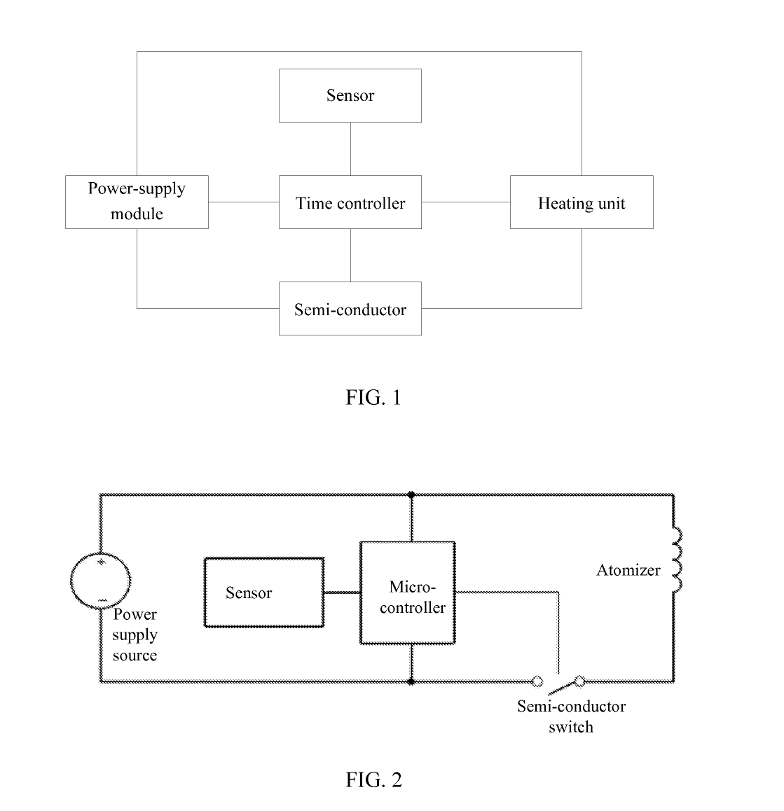

FIG. 1 illustrates a schematic diagram of an electronic cigarette with prolonged heating protection and a protection method of the same, according to the present invention. In specific, the electronic cigarette with prolonged heating protection includes a sensor used to produce a smoking start signal upon sensing a beginning of a smoking process and produce a smoking finish signal upon sensing an end of a smoking process, a time controller connected to the sensor and setting a preset smoking time T0, a heating unit connected to the time controller and used to create a high temperature to heat and atomize tobacco tar inside the electronic cigarette, a semi-conductor switch used to control work states of the heating unit, and a power supply module connected to the heating unit via the semi-conductor switch. The semi-conductor switch is further connected to the time controller.

The sensor produces a smoking start signal upon sensing a beginning of a smoking process, and then sends the smoking start signal to the time controller. When the time controller receives the smoking start signal, the time controller turns the semi-conductor switch on and enables the power supply module to supply power to the heating unit, and the time controller begins to do time counting upon receiving the smoking start signal. If the counted time is longer than or equal to the preset smoking time T0, the time controller turns the semi-conductor switch off and forces the power supply module to stop supplying power to the heating unit;

The sensor produces a smoking finish signal upon sensing an end of a smoking process, and sends the smoking end signal to the time controller. When the time controller receives the smoking end signal, the time controller turns the semi-conductor switch off and forces the power supply module to stop supplying power to the heating unit.

By the cooperation of the sensor and the time controller, the smoking process can be started or ended automatically. Moreover, because the time of every smoking process is shorter than the preset smoking time T0, safety the use of the electronic cigarette is ensured.

Furthermore, a time deleting device is mounted inside the time controller. The time deleting device deletes time records stored in the time controller only when the time controller receives a smoking end signal, thereby making the next smoking process be normally performed.

In specific, the particular length of the preset smoking time T0 can be set according to the particular type of the electronic cigarette, for example, the preset smoking time T0 can be ranged from 3 to 20 seconds.

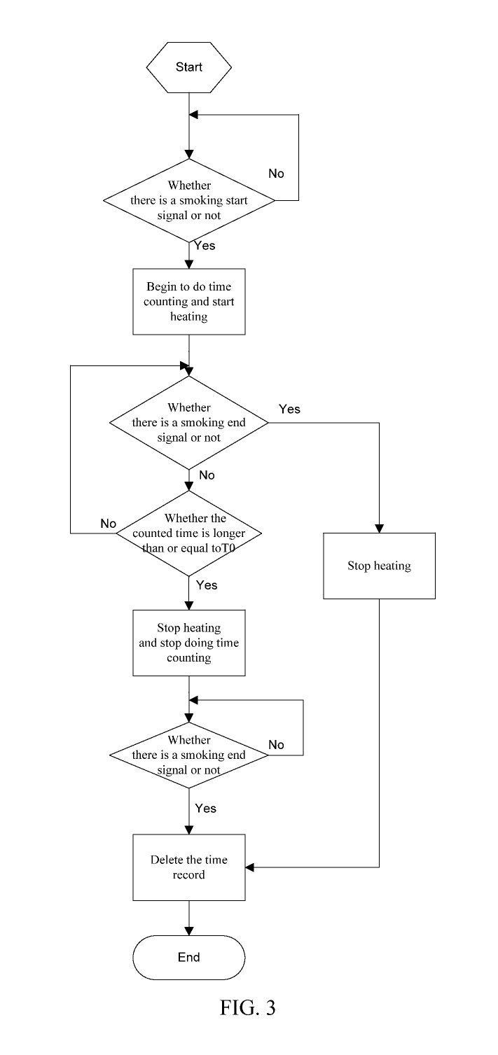

FIG. 2 illustrates a circuit diagram of the electronic cigarette with prolonged heating protection according to the present invention. A power supply source used as the power supply module is always connected to a micro-controller. The micro-controller can be any one of a MCU, a CPU, a GPU or a specific ASIC (Application Specific Integrated Circuit) chips, as long as it has the same function with the time controller and can response to the smoking start signals and smoking end signals sent from the sensor.

The heating unit is mounted inside an atomizer. By the heating unit; the atomizer can atomize the tobacco tar stored inside the electronic cigarette. Furthermore, the atomizer, the power supply source, and the semi-conductor switch form a loop circuit. The semi-conductor switch is controlled by the micro-controller. When the counted time is shorter than T0, the semi-conductor switch is turned on. When the counted time is longer than or equal to T0, or when the smoking end signal is generated, the semi-conductor switch is turned off. As a preferred option, the semi-conductor switch is a MOSFET, which can response to signals of the micro-controller rapidly and accurately.

FIG. 3 illustrates a flow chart of the protection method of the electronic cigarette according to the present invention. The electronic cigarette first detects whether there is the smoking start signal or not, once the smoking process starts, the time counting and the heating process must be started, and then the electronic cigarette comes into a normal working process.

Thereafter the micro-controller changes to detect whether there is the smoking end signal or not, once the smoking end signal occurs, the heating process ends. Before the micro-controller receives the smoking end signal, it further detects whether the smoking time is longer than or equal to T0 or not, wherein T0 is a safety threshold time. If the smoking time is longer than or equal to T0, the heating process and the time counting will be ended, or else the heating unit keeps its normal working process.

If the heating process is forced to be ended by the detected smoking end signal, the time records should be deleted; or else, if the heating process is ended for the reason that the counted time is longer than or equal to T0, the time records will be deleted only after the micro-controller detects a smoking end signal, thereby avoiding the case that the heating process will be restarted for the reason that the time records is deleted by mistake.

While the present invention has been described with reference to preferred embodiments, it will be understood by those skilled in the art that various changes may be made and equivalents may be substituted without departing from the scope of the present invention. But all the changes will be included within the scope of the appended claims.

1. An electronic cigarette with prolonged heating protection, characterized in that the electronic cigarette with prolonged heating protection includes:
a sensor used to produce a smoking start signal upon sensing a beginning of a smoking process and produce a smoking finish signal upon sensing an end of a smoking process;
a time controller connected to the sensor and setting a preset smoking time T0;
a heating unit connected to the time controller and used to create a high temperature to atomize tobacco tar inside the electronic cigarette;
a semi-conductor switch used to control work states of the heating unite;
and a power supply module connected to the heating unit via the semi-conductor switch; the semi-conductor switch further connected to the time controller;
wherein when the time controller receives the smoking start signal, the time controller turns the semi-conductor switch on and enables the power supply module to supply power to the heating unit, and the time controller begins to do time counting upon receiving the smoking start signal;
if the counted time is longer than or equal to the preset smoking time T0, the time controller turns the semi-conductor switch off and forces the power supply module to stop supplying power to the heating unit;
and when the time controller receives the smoking end signal, the time controller turns the semi-conductor switch off and forces the power supply module to stop supplying power to the heating unit.

2. The electronic cigarette with prolonged heating protection of claim 1, characterized in that a time deleting device is mounted inside the time controller, and the time deleting device is used to deleting time records stored in the time controller when the time controller receives a smoking end signal.

3. The electronic cigarette with prolonged heating protection of claim 1, characterized in that a length of the preset smoking time T0 ranges from 3 to 20 seconds.

4. The electronic cigarette with prolonged heating protection of claim 1, characterized in that the semi-conductor switch is a MOSFET.

5. A prolonged heating protection method for an electronic cigarette, characterized in that the method includes these steps:
step1: presetting a smoking time T0;
step2: using a sensor to detect a smoking start signal; if the sensor detects the smoking start signal, using a time controller to turn a semi-conductor switch on and connect a heating unit with a power supply module, using the heating unit to start heating, using a time controller to begin to do time counting at the same time, and turning to step3;
if the sensor does not detects the smoking start signal, using the sensor to continue to detect the smoking start signal;
step3: determining whether the smoking time is shorter then the preset smoking time T0; if the smoking time is shorter then the preset smoking time T0, turning to step4;
if the smoking time is longer than or equal to the preset smoking time T0, using the time controller to turn the semi-conductor off and disconnect the heating unit from the power supply module;
step4: detecting a smoking end signal; if the smoking end signal is detected, using the time controller to turn the semi-conductor off and disconnects the heating unit from the power supply module;
if the smoking end signal is not detected, turning to Step3.

6. The prolonged heating protection method for an electronic cigarette of claim 5, characterized in that Step4 further includes deleting time records stored in the time controller when the time controller turns the semi-conductor off and disconnects the heating unit from the power supply module.

7. The prolonged heating protection method for an electronic cigarette of claim 5, characterized in that range of the preset smoking time T0 is from 3 to 20 seconds.
